(19) United States
(12) Patent Application Publication
(10) Pub. No.: US 2017/0193075 A1
(43) Pub. Date: Jul. 6, 2017

(54) SYSTEM AND METHOD FOR AGGREGATING, CLASSIFYING AND ENRICHING SOCIAL MEDIA POSTS MADE BY MONITORED AUTHOR SOURCES

(71) Applicant: ddductr UG, Siegen (DE)

(72) Inventors: Simon Hegelich, Siegen (DE); Kolja Hegelich, Siegen (DE)

(21) Appl. No.: 14/987,383

(22) Filed: Jan. 4, 2016

(51) Int. Cl. G06F 17/30; G06N 7/00; G06N 99/00; H04L 12/58

(52) U.S. Cl. CPC G06F 17/30598; H04L 51/16; H04L 51/32; G06F 17/30864; G06N 7/005; G06N 99/005

(57) ABSTRACT

Provided is a system and method for aggregating, classifying, and enriching social media. Machine learning techniques and automatic analysis is performed on posts aggregated from different social media sites. The posts are curated to be sourced from the official accounts of popular or well-performing public figures, brands, and business entities. Posts are classified in two levels to better organize the posts into differentiated feeds by first categorizing the sources by an identity category, such as musician, actor, athlete, miscellaneous celebrity, news and lifestyle, brand, or business entity, and the posts themselves into music, videos, photos, upcoming events, location-specific, concerts, news and lifestyle, and community interaction. Posts are enhanced and enriching by adding hyperlinks, modifying appearance, and integrating with a calendar or a map for organizing the posts.

### FIELD OF THE INVENTION

The present embodiments relate to data aggregation and classification, and more particularly, to aggregation and classification of social media content.

### BACKGROUND OF THE INVENTION

Social media platforms, such as Twitter and Facebook, have become increasingly used by public figures and business entities to disseminate information through social media posts, information such as announcements, commentary, photos, videos, and hyperlinks to other internet content. Users have also increasingly turned to social media platforms for alerts of news and current events. A user of a particular social media platform may “like,” “follow,” “subscribe to,” or otherwise cause the posts from public figures and business entities to populate the user's social media feed.

One disadvantage of following such public figures and business entities is that their posts are included in the user's feed alongside the user's social network of friends, family, and acquaintances. While certain platforms allow the users to group their Friends or Followed into separate feeds, thereby providing the possibility of separating a public figure/business from the other posts, this is performed manually.

Another disadvantage of following such public figures and business entities is that posts in the user's newsfeed, composed of all the posts of the followed entities, are typically arranged in date-based order, chronologically, with the ordering date taken from the later of the date of the posting, or the date of the latest comment to the posting.

Another disadvantage of following such public figures and business entities is the user's newsfeed includes all posts from the followed entities, friends, family and acquaintances, without regard to content format or content topic.

It would be desired to provide a system and method for presenting aggregated social media posts from public figures and business entities without the disadvantages described above.

### BRIEF SUMMARY OF EMBODIMENTS OF THE INVENTION

A system and method for aggregating, classifying, and enriching social media posts made by monitored author sources. A set of authors are identified from querying a plurality of databases storing ranking data. One or more social media accounts are identified as authored by each author of the set of authors, by submitting a query to a web search engine comprising at least the author and a social media platform name, performing Bayesian probability evaluation on a set of results returned from the web search engine to evaluate a probability of authorship, and based on the probability of authorship, identifying the one or more social media accounts authored by each author of the set of authors. A posts aggregation module configured for interacting with APIs provided by one or more social media platforms to retrieve a set of posts from said one or more social media accounts authored by each author of the set of authors. A semantic analysis module configured for performing at least two levels of semantic analysis on the set of posts to assign at least two categories of a plurality of system categories to a post of the set of posts, the first level of semantic analysis for assigning an identity-type category based on the author of the post, and the second level of semantic analysis for assigning a content-type category. Further, a posts enrichment module configured for analyzing the content of posts for one or more keywords, and for modifying posts by adding a hyperlink to the post relevant to said one or more keywords.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates an example of an enhanced social media system for the aggregating, classifying and enriching of social media posts made by monitored author sources, according to some embodiments.

FIG. 2 illustrates an example of a flow diagram for a process employed by author selection module for author selection and posts retrieval, according to some example embodiments.

FIG. 3 illustrates an example of a flow diagram for a process employed by social media account identification module for automated account detection, according to some example embodiments.

FIG. 4 illustrates an example a flow diagram for a process employed by semantic analysis module to classify authors into categories, according to some example embodiments.

FIG. 5 illustrates an example of a flow diagram for a process employed by posts enrichment module to add a link to web resources for a post, according to some example embodiments.

FIG. 6 illustrates an example of a flow diagram for a process employed by posts enrichment module to add a link to a relevant retail source for a post, according to some example embodiments.

FIG. 7 illustrates an example of a flow diagram for a process employed by posts enrichment module to add a link to an alternate marketplace, according to some example embodiments.

FIG. 8 illustrates an example of a flow diagram for a process employed by posts enrichment module to manage the sponsored posts handled by the enhanced social media system 100.

### DETAILED DESCRIPTION OF EMBODIMENTS

In the following description numerous specific details have been set forth to provide a more thorough understanding of embodiments of the present invention. It will be appreciated however, by one skilled in the art, that embodiments may be practiced without such specific details or with different implementations for such details. Additionally some well-known structures have not been shown in detail to avoid unnecessarily obscuring the present embodiments.

Other and further features and advantages of the present embodiments will be apparent from the following descriptions of the various embodiments when read in conjunction with the accompanying drawings. It will be understood by one of ordinary skill in the art that the following embodiments and illustrations are provided for illustrative and exemplary purposes only, and that numerous combinations of the elements of the various embodiments of the present invention are possible. Further, certain block diagrams are not to scale and are provided to show structures in an illustrative manner. Exemplary systems and processes according to embodiments are described with reference to the accompanying figures. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, or a stand-alone device. The process can be implemented as instructions executed by such hardware, hardware alone, or any combination thereof. The software may be stored on a program storage device readable by a machine.

In addition, those of ordinary skill in the art will recognize that devices of a less general purpose nature, such as hardwired devices, field programmable logic devices (FPLDs), including field programmable gate arrays (FPGAs) and complex programmable logic devices (CPLDs), application specific integrated circuits (ASICs), or the like, may also be used without departing from the scope and spirit of the inventive concepts disclosed herein.

In accordance with one embodiment of the present invention, the method may be implemented on a data processing computer such as a personal computer, workstation computer, mainframe computer, or high performance server running an OS such as Solaris® available from Sun Microsystems, Inc. of Santa Clara, Calif., Microsoft® Windows® XP and Windows® 2000, available from Microsoft Corporation of Redmond, Wash., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like.

Overview

Provided are systems and computer-executed methods for aggregating, classifying, and enriching social media posts by monitored author sources, including public figures, brands, and business entities. Features of some example embodiments are described hereinafter. The system and methods provide the user with the ability to browse feeds of social media posts from monitored author sources, which are classified by type, such as musician, actor, athlete, miscellaneous celebrity, news and lifestyle, brand, or business entity, and further classified by content type, such as music, videos, photos, upcoming events, location-specific, concerts, news and lifestyle, and community interaction. For example, an aggregated feed of posts by professional athletes or by popular musicians is made available to a user.

Sources of social media postings are selected to be monitored through an automated process. A list of monitored author sources, such as names of public figures, brands, and business entities, is generated and updated periodically by accessing and parsing electronically published rankings for public figures and popular brands and business entities. The names on the generated list, along with one or more names of social media platform providers, are each submitted into a web search engine. The results of the search are analyzed using statistical analysis to determine one or more official social media accounts belonging to a particular name or entity. Based on metadata obtained from the account, the names are classified into particular established categories, such as musician, actor, athlete, miscellaneous celebrity, news and lifestyle, brand, or business entity.

Upon identification of the official accounts for the names, posts are retrieved from the accounts, including text content, hyperlinks, metadata, and attached content, such as images and video. The posts undergo two levels of classification. In a first level, the posts are classified in an automated process into one of the established identity categories, such as musician, actor, athlete, miscellaneous celebrity, news and lifestyle, brand, or business entity, based on the metadata associated with the accounts.

In a second level of classification, the postings are further classified into one of several predetermined categories of posts, such as music, videos, photos, upcoming events, location-specific, concerts, news and lifestyle, and community interaction, in an automated process. Unsupervised machine learning is used on the text of the retrieved posts within each identity category to perform semantic clustering, a process that clusters semantically similar posts into common clusters. The clusters are then classified into one of several predetermined content-type categories of posts, such as music, videos, photos, upcoming events, location-specific, concerts, news and lifestyle, and community interaction. These classified clusters are used as training data for subsequent supervised learning for classifying newly retrieved information. For example, supervised machine learning is applied to subsequently retrieved posts to classify them into one of the remaining predetermined categories. Posts identified as being attached with or linked to photo and video content are classified to the photos and videos categories, respectively, without the need for any application of machine learning techniques.

Once classified into a category, particular processes are applied to posts within each category enrich the posts. For posts classified as relating to an upcoming event, processes are employed to identify the true date mentioned in the post, and within this category, the true date is the basis for the order of posts instead of the post's timestamp. For example, “tomorrow” is analyzed as requiring adding one day to the timestamp, “Monday” is analyzed as advancing the true date to the Monday after the timestamp. The event description is isolated from the text of the posting, and added to a calendar interface with the true date.

For posts classified into a location-based category, the original posts enriched by being integrated and marked on a map interface, allowing a user to browse for the event on the map, especially events within a radius from the user's current location.

For posts classified as relating to particular recording of an audio work, hyperlinks for sources supplying a related or specified musical work are added to the post to enrich the post.

The original posts may be enriched by employing a targeted marketing process to emphasize sponsored posts. For example, the post owners can pay a fee to promote certain posts by forcing them to appear within the first few posts within a category for any end-user. Metadata is added to the post to signal the server to serve the posts in the promotional order. Such enrichment may be applied to posts relating to sponsored events for promotion of the event.

For posts classified as relating to a concert, inserting hyperlinks linking to a ticket sales service's listing for the concert enriches the original posts. Posts from this category overlaps with the upcoming events category.

For posts classified as relating to an author's interaction with single users, these posts are gathered into a Community category. Often such communications are not interesting to the majority of the users subscribed to the author's feeds, and filtering these posts into its own category beneficially improves the interest of the author's other content.

The posts from each category, once processed through the enrichment processes, are now available to be served to the end user's client application. According to some embodiments, the application provides an interface for the user to browse the posts by the major categories of: musician, actor, athlete, miscellaneous celebrity, brand, or business entity. Within each category, the interface allows a user to browse posts by the post type: music, videos, photos, upcoming events, location-specific, concerts, news and lifestyle, and community interaction. The interface also allows a user to select a particular name of a public figure, brand, or business entity, and browse all posts authored by the public figure, brand, or business entity, which are also classified by post type.

Enhanced Social Media System

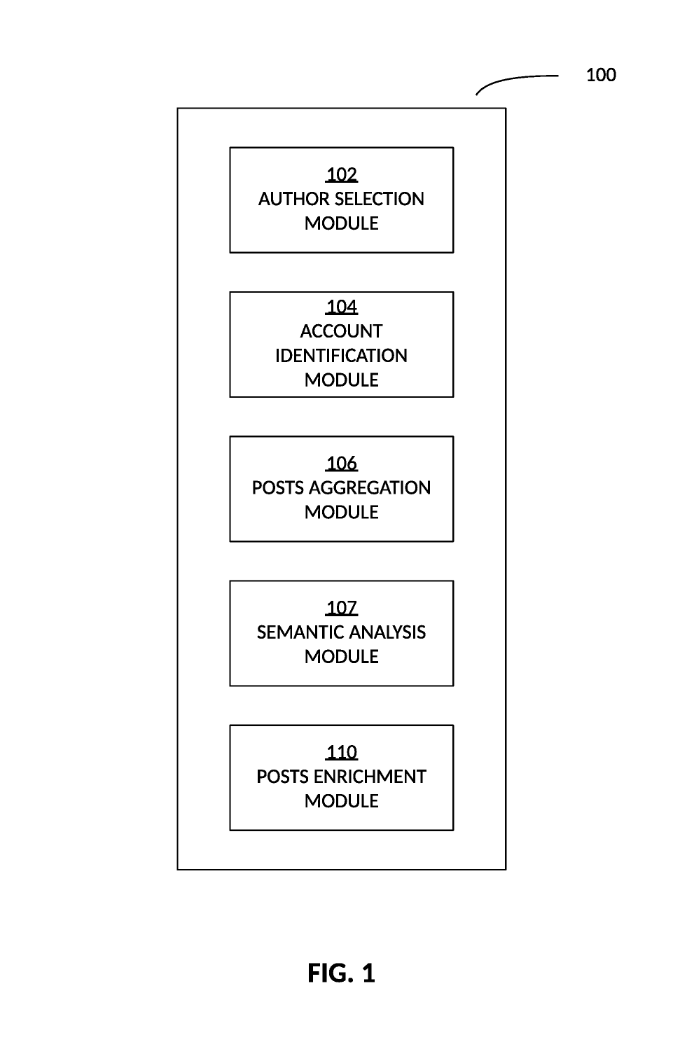

FIG. 1 illustrates an example of an enhanced social media system 100 for the aggregating, classifying and enriching of social media posts made by monitored author sources, according to some embodiments.

The enhanced social media system 100 includes server-side components, including author selection module 102, social media account identification module 104, posts aggregation module 106, semantic analysis module 108, and posts enrichment module 110. Modules 102-110 work together to produce an enhanced feed of social media posts for public figures and popular brands and businesses. The system 100 receives requests for the posts from client applications, and provides the posts to the requesting clients.

Each of the modules will be further described herein. Author selection module 102 interacts in an automated process with APIs provided by various ranking sources to determine a set of popular public figures, brands, and business entities, which become regularly monitored sources of social media posts for the system. Ranking sources providing such APIs for accessing ranking data include Billboard charts (for songs), Twitter (for top influential Twitter users), Totem (for top brands), and CBS Sports (NFL, MLB, NBA, NHL, NCAA, PGA).

Social media account identification module 104 is configured submit the monitored source names as determined by the author selection module 102, with the names of one or more social media platforms, to a web search engine for a web search for the purpose of finding and verifying the official social media accounts authored by the monitored sources. Results of the search are analyzed to determine the official account or page URLs and usernames, for example, on Twitter, Facebook, or Instagram. In some embodiments, the process for analyzing the search results comprises a Bayesian evaluation, as follows. Search results are assigned a probability that it is an official social media account of the monitored source, authored or otherwise controlled by the monitored author source. The first, or top, search result is considered to be most likely the best result, and assigned the highest probability of authorship. The probability assigned to the first search result is the prior probability in the Bayesian analysis. The text from the social media pages of the search results is mined; the words on the additional social media account are expected to be similar as the words on the social media account from the first search result. In some embodiments, the lower-ranked search results are evaluated, and are assigned a lower prior probability. The algorithm stops in case a defined threshold probability is reached.

In some embodiments, some ranking sources, such as Top Influential Twitter Users, comprise verified user accounts. Where a verified Twitter account is identified for a public figure, brand, or business, metadata or posts from the account can be analyzed, in conjunction with a web search engine query, to determine official accounts from other social media platforms. In some embodiments, Bayesian probability methodologies are used to assign probabilities to accounts found on other social media platforms, using the verified Twitter account as the Bayesian “prior” for the evaluation. In some embodiments, the monitored sources names comprise a set of over 10,000 names. The system uses the above-described evaluation to automatically associate one or more social media account URLs with each name.

Posts aggregation module 106 is configured to retrieve from social media platforms the latest posts from the verified social media accounts of monitored source names. In some embodiments, posts aggregation module 106 interacts with APIs provided by the social media platforms to retrieve posts from one account at a time, repeating the procedure for all monitored sources. Alternatively, depending on the configuration of the API, posts may be retrieved from several accounts at once. Posts aggregation module 106 is configured to repeat the retrieval process to retrieve latest posts from social media sources. In some embodiments, the retrieval is triggered by an end-user requesting a refreshing of posts. In some embodiments, the retrieval repeats at set time intervals. In some embodiments, posts for only a portion of the monitored sources names are retrieved at a time.

Semantic analysis module 108 is configured to perform semantic analysis on the posts fetched by the posts aggregation module 106. At least two levels of semantic analysis are performed to assign categories to the posts. At a first level, each of the monitored sources is classified into an identity type, such as musician, actor, athlete, miscellaneous celebrity, news and lifestyle, brand, or business entity. In some embodiments, the semantic analysis module 108 determines which of the monitored Facebook Pages is already associated with one of the system's identity types. For example, Kenny Loggins's Facebook Page identifies him as “musician/band.”

However, some public figures tend to use other terms to describe their identity type. For example, certain musicians merely identify as a “public figure,” or by a category that is misleading, ironic, or otherwise non-standard, such as “middle school.” Several of these monitored sources with non-standard categories as identified on their Facebook pages are manually classified. Then they are used by the semantic analysis module 108 as machine learning training examples. By using machine learning classification techniques with these training examples, such as the K-Nearest Neighbors, Random Forrest or Support Vector Machine algorithms, the remaining monitored sources are classified into one of the system's identity types. In some embodiments, metadata obtained from the accounts, including number of friends and followers, identity types of the friends or followers, date of creation of the account, and frequency of posts, are used with the machine learning classification techniques to identify the identity type of the accounts. The classification of all monitored sources allows an end-user to filter the enhanced social media system's 100 posts by identity type, and to tailor further classification of the monitored user's individual posts into subcategories at the second level of semantic analysis. For example, posts from musicians only are filtered into an area of the client application user interface for viewing.

At the second level of semantic analysis, semantic analysis module 108 analyzes the content of the posts to further classify the posts into content-type categories, such as music, videos, photos, upcoming events, location-specific posts, concerts, news and lifestyle, and community interaction. In some embodiments, the types of content-type categories available for classifying a post depends on the post's author's identity type. For example, while a musician may have posts relating to an upcoming concert date, which after second-level semantic analysis would be classified into the concert and upcoming events categories, posts authored by a brand would not be candidates for the concert category; semantic analysis for such posts may exclude the concert category to avoid misclassification.

Unsupervised machine learning techniques are used by the semantic analysis module 108 to create clusters from the set of newly fetched posts retrieved by the posts aggregation module 106. In some embodiments, the unsupervised clustering is achieved using a document-term matrix, onto which a hierarchical cluster analysis is applied. In some embodiments, the retrieved posts are first separated into categories based on the identity type of the post's author, such as musician, actor, athlete, miscellaneous celebrity, news and lifestyle, brand, or business entity before unsupervised machine learning techniques are used to create clusters. The clusters are then assigned to a particular content-type category to form training data for creating a supervised classification model for posts. Subsequently retrieved posts are classified into one of the content-type categories using the supervised classification model.

In some embodiments, media data included in the posts are identified based on their file type, and such posts are quickly classified into particular content-type categories without employing any machine learning processes. For example, attached media having a file type of JPG, PNG, or GIF are classified as photos. If text is also included with the posts, the post may be classified and used by the supervised machine learning model to further classify the post into one of the other content-type categories, such as the concert or upcoming event categories.

Posts enrichment module 110 then enhances the posts depending on the content of the posts. In some embodiments, for posts classified as related to Music, URLs to online stores for purchasing or accessing the music are added to the posts. Posts are parsed to extract pre-specified keywords that can be used to search for retail opportunities relating to the post. For example, a post mentioning a song name is enhanced by adding a URL to a retail source for buying the song; a post mentioning a product is enhanced by adding a URL to a retail source for buying the product. In some embodiments, certain keywords may be sponsored in a marketing or promotional scheme, whereby a sponsor pays for the enhancement to posts. In some embodiments, for posts classified as related to Concerts, the name of the artist is identified, and along with the location of the user, a URL linking the user to purchase a ticket at a location near the user, which is determined by the location data received from a client, is automatically inserted into the post for a particular end-user.

In some embodiments, posts containing a URL to one retail source for a song or album may be enhanced by adding, or substituting, the provided URL with a URL for another source of the song or album. For example, a post originally having a URL to iTunes is enhanced by providing additional URLs to Android-compatible sources, such as Google Play, Amazon.com, or 7digital, or to streaming sources such as Spotify. The additional URLs are determined by the post enrichment module 110 through an automated process of bootstrapping the metadata obtained from the original URL. For example, a URL for a song on iTunes is given in a post. Using APIs provided by iTunes, identifying information about the song or album is obtained, such as the title, artist and year. The identifying information is used by post enrichment module 110 to form a search query for submitting to a search engine along with other keywords to determine one or more URLs for purchasing or accessing the song from different online retail sources. In some embodiments, the system uses the identifying information to form a query for submitting directly into an input interface provided by a particular retail source, such as Google Play or Spotify, to determine an alternative URL. The URLs are then added to, or used in substitution for, the original URL provided by the post when the post is ultimately provided to the end user's client application.

Post enrichment module 110 can also be used to enrich or enhance a post by re-ordering or re-arranging posts clustered in the content-type “Upcoming Events” by assigning a future date, or an event date attribute, to the post corresponding to the mentioned event, a date that is different from the date on which the post was posted. In some embodiments, date markers, such as date-related words, in a post are identified, standardized, and extracted from the post. For example, “tomorrow” and “next Wednesday” in a post such as “John Doe's concert is happening next Wednesday” are converted into dates of a standard format, such as yyyy-mm-dd, by extrapolating based on the posting date of the post. Dates written or abbreviated in a non-standard manner are identified and converted into a standard format for the event date attribute. The remainder of the message is used as the event title for the upcoming event occurring on the assigned date. In some embodiments, once an event date attribute is determine for the upcoming event, the upcoming event is arranged in an Upcoming Events feed in the order of the event. In some embodiments, the upcoming event is posted to a calendar interface on the assigned date. In some embodiments, a process is applied to a post whereby the words of a post are compared with a list of standard date formats to find a match in format. Once an Upcoming Event is identified, it is used as a training example with supervised machine learning techniques to identify which subsequent posts are also related to the same event. For example, other posts clustering in the same cluster as some identified upcoming event posts are also classified to the same upcoming event. In some embodiments, the posts are served to the user in a single feed on a client interface.

Post enrichment module 110 can also be used to enrich or enhance a post by identifying a location for an Upcoming Event. In some embodiments, the post enrichment module 110 determines whether an Upcoming Event post mentions a location marker, or a location-related word, and determines the location attributes of the location marker. For example, a post may say, “See you all at my presentation tomorrow at ABC Books in San Francisco!” The post enrichment module 110 matches “San Francisco” and/or “ABC Books” to list of known places in a database, and the geographic location (e.g., latitude and longitude) of the place is added to the post's metadata, allowing a marker to be placed on a map to indicate the event. In some embodiments, the post enrichment module 110 determines that the post does not mention any location. The post enrichment module 110 submits a web search to a search engine, such as google.com. The results of the web search are analyzed to determine a likely location for the Upcoming Event based on certain parameters identified for the event, such as artist, event title, date, and time. The discovered location is added to the post's metadata as a location attribute, which when read by a client application, allows a marker to be placed on a map to indicate the event thereon.

The enhanced social media system 100 can be employed in a directed manner by post authors to modify, enhance, or otherwise adjust the posts before they are served to the clients. In some embodiments, in such author-driven content management, posts enrichment module 110 is configured to receive instructions within the metadata of the posts to modify a post. For example, a brand can sponsor a post to stay at the top of a feed for a category for a week by including in its Facebook post the necessary metadata for the posts enrichment module 110 to apply the modification to the post after parsing the metadata. In some embodiments, up to 150 metadata fields are retrieved from a Facebook post, and analyzed by the posts enrichment module 110.

The following describes examples of processes employed by modules 102-110 according to some embodiments.

### EXAMPLE 1

### Author Selection and Posts Retrieval

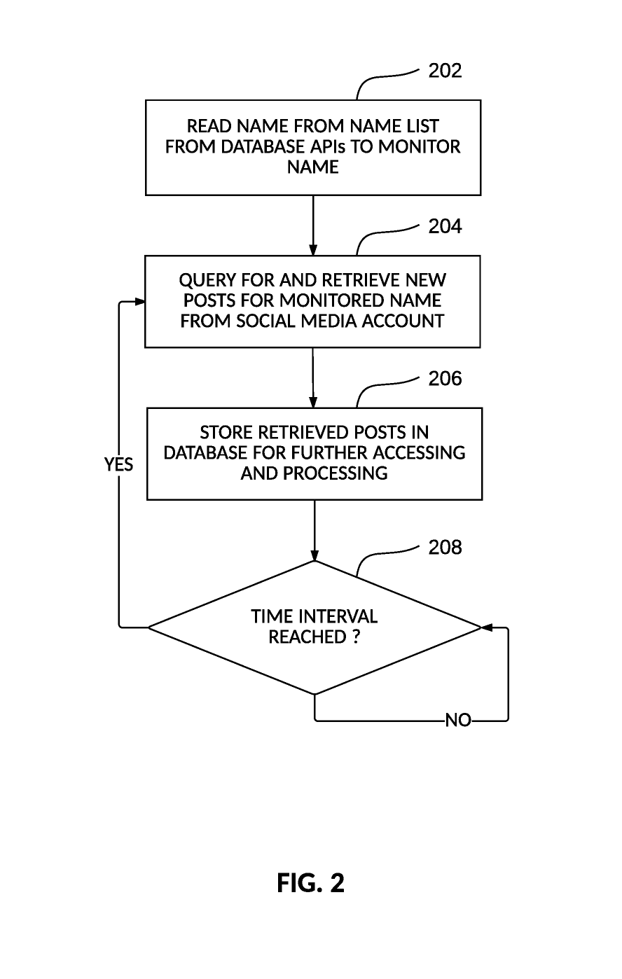

FIG. 2 illustrates an example of a flow diagram for a process employed by author selection module 102 for author selection and posts retrieval, according to some example embodiments. At step 202, a name list 210 is read from a database through an API provided by the database, such as the Billboard music charts database, the Twitter influential users database, the Totem database of brands, or sports databases. At step 204, new posts for the names are queried and retrieved from a social network after a certain time interval has passed since the last query. At step 206, the posts are stored in the enhanced social media system's database, which makes the posts and accompanying data 212 available to the other modules for further accessing and processing. At step 208, if the time interval since the last query has passed, step 204 is repeated. If the time interval has not passed, then the process waits.

### EXAMPLE 2

### Automated Account Detection

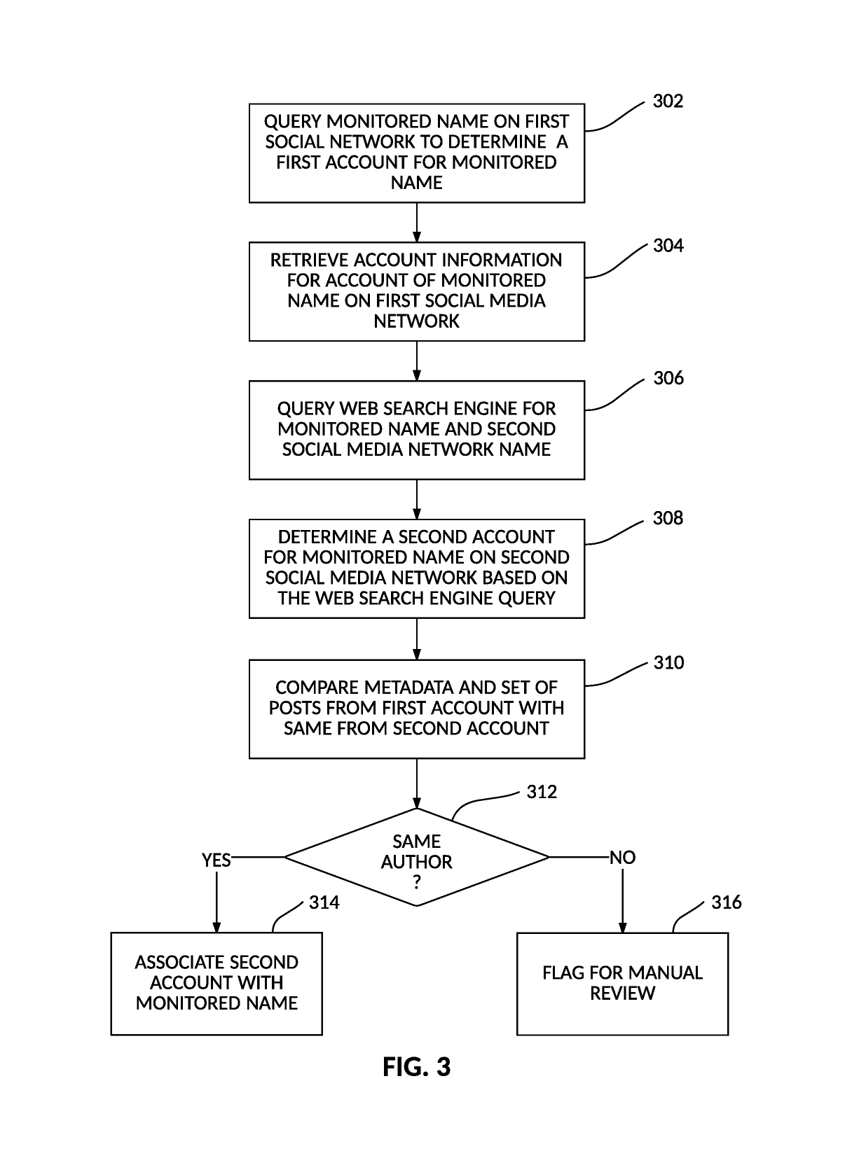

FIG. 3 illustrates an example of a flow diagram for a process employed by social media account identification module 104 for automated account detection, according to some example embodiments. At step 302, the monitored name is searched on a first social network, such as Twitter. At step 304, account information from the first social network is retrieved. At step 306, a web search is performed on the name, plus a name of a second social network, and at step 308, the official social media account on the second social media network is determined for the monitored name based on the web search. At step 310, the accounts metadata and a sample of posts from the account from the first social network and the account from the second social network are compared. At step 312, if the system determines that the accounts appear to be from the same author, then at step 314, the respective account information is stored in the system 100's database as associated with the monitored name. In some embodiments, Bayesian evaluation is used on the posted words from the accounts to determine the probability that the accounts come from the same author. For example, the probability of identical authorship is deemed higher if the amount of words that match in the accounts is higher. In another example, the order of the search results is evaluated as well, such that the first search result is given a higher probability. If the system determines that the accounts are not from the same author, then at step 316, the account is flagged for manual review.

### EXAMPLE 3

### Semantic Analysis

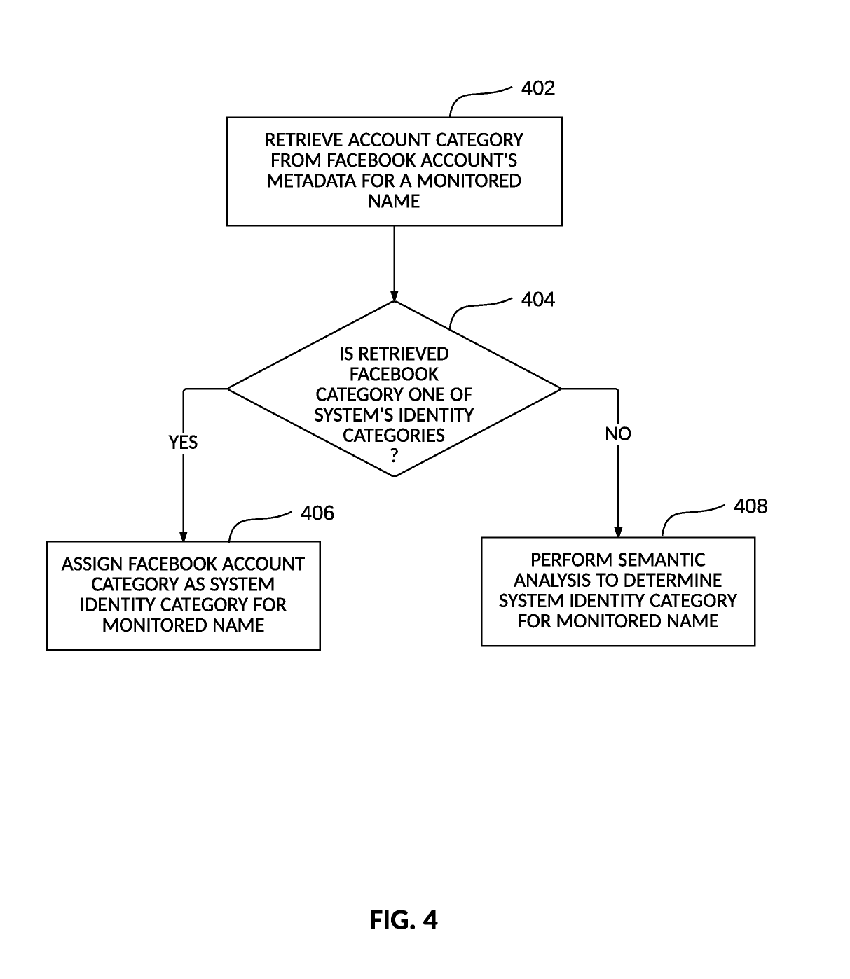

FIG. 4 illustrates an example a flow diagram for a process employed by semantic analysis module 108 to classify authors into categories, according to some example embodiments. At step 402, the Facebook page category for a monitored name is retrieved. At step 404, if the Facebook category is one of the categories used by the system 100 for classification, such as musician, actor, athlete, miscellaneous celebrity, news and lifestyle, brand, or business entity, then at step 406, the Facebook category is assigned as the category for the monitored name. At step 408, if the Facebook categories do not match one of the identity categories used by the system, then at step 410, semantic analysis is performed on the user data to determine which of the identity categories is appropriate for the monitored name. Semantic analysis includes using machine learning classification techniques on the account data, for example K-Nearest Neighbors algorithm, to determine the correct category for the monitored name.

### EXAMPLE 4

### Linking to Resources

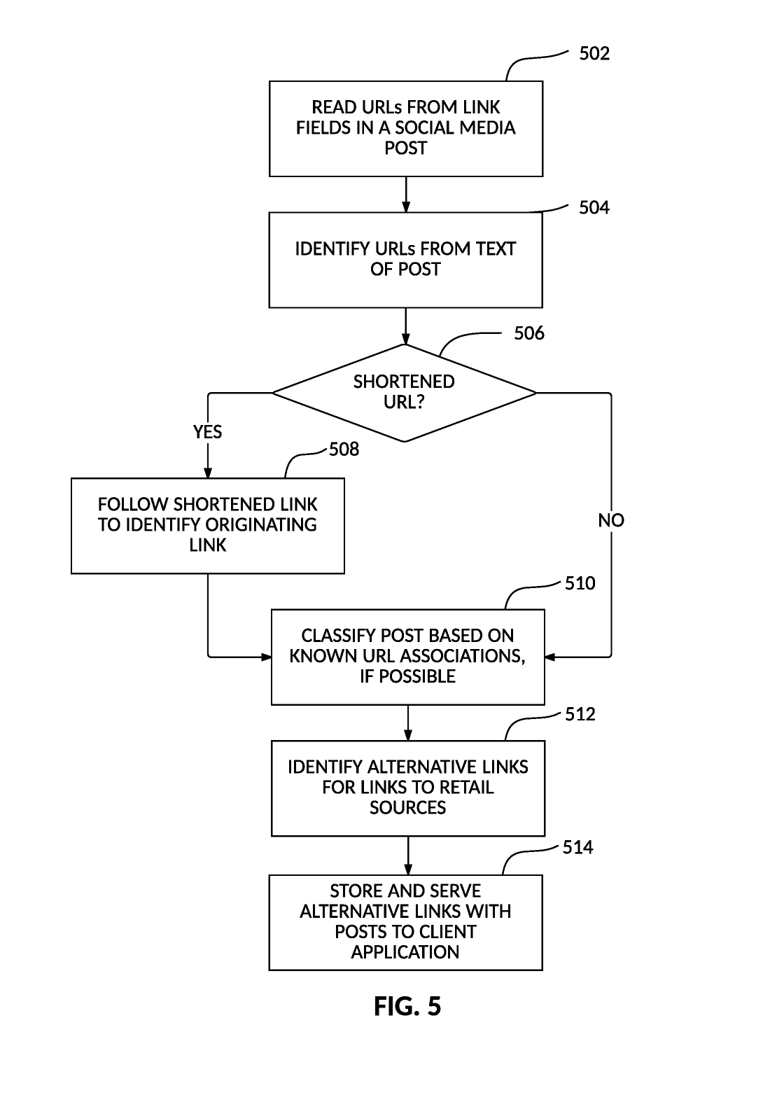

FIG. 5 illustrates an example of a flow diagram for a process employed by posts enrichment module 110 to add a link to web resources for a post, according to some example embodiments. At step 502, any URLs included in a post is read from the link fields in the metadata. Then at step 504, URLs are identified from the post's text. At step 506, if the URL is a shortened link from a service such as Bitly, then at step 508, the originating link is determined by the module 110 by following the hyperlink and all redirects until originating link is found. At step 510, if the originating link is to a known provider associated with a particular category of content, for example, a music streaming service, then the post is classified as music, the known associated category. At step 512, alternative links for the same product or content at a different source are found. At step 514, the alternative links are stored and served with the post to a client application.

### EXAMPLE 5

### Linking to Relevant Resources

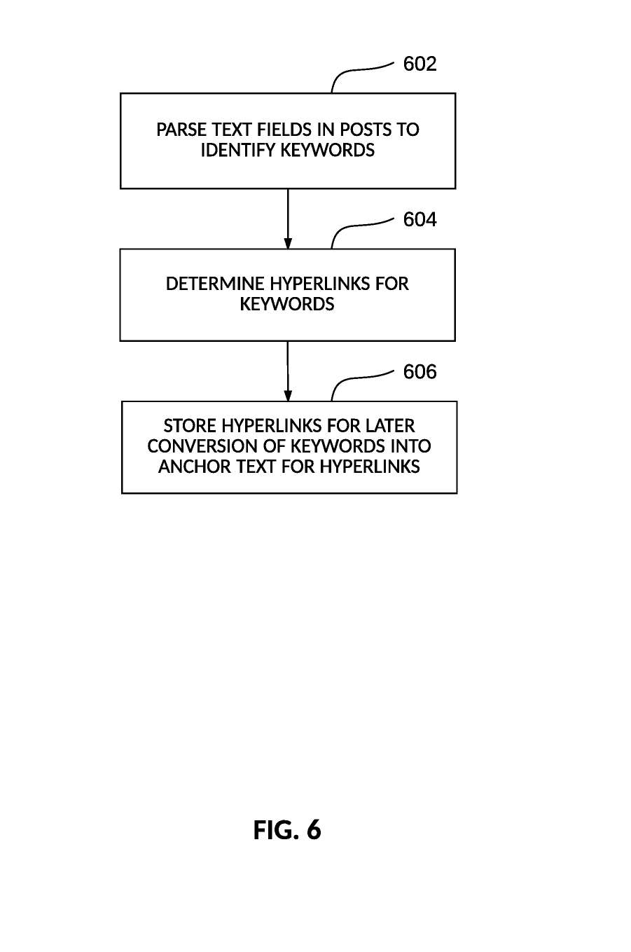

FIG. 6 illustrates an example of a flow diagram for a process employed by posts enrichment module 110 to add a link to a relevant retail source for a post, according to some example embodiments. At step 602, the text fields for the posts are analyzed for keywords. At step 604, hyperlinks are determined for the keywords. At step 606, the links are stored in the database for system 100. The keywords can be converted into anchor text for hyperlinks to relevant resources for the keywords when the post is served to a client application.

### EXAMPLE 6

### Linking to Alternate Marketplaces

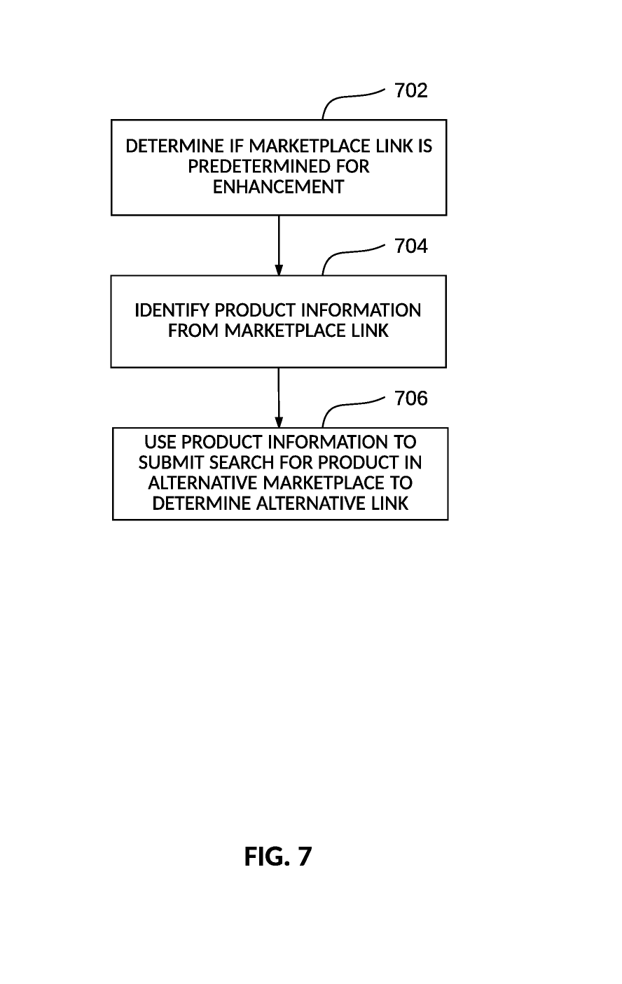

FIG. 7 illustrates an example of a flow diagram for a process employed by posts enrichment module 110 to add a link to an alternate marketplace, according to some example embodiments. At step 702, a marketplace link within a post is analyzed and flagged if it is a marketplace predetermined for enhancing with alternative marketplaces. For example, in some embodiments, iTunes links are flagged to be supplemented with an alternate link to Google Play. At step 704, the marketplace link is used with the API provided by the marketplace source to determine product information for the linked product, such as an artist name, song title, year, album name for a link to a song. At step 706, using this product information, a search is submitted to the alternate marketplace. If the product is found at the alternate marketplace, then the product data and alternate links are stored into the database for system 100. The links are served with the post to the client application.

### EXAMPLE 7

### Author-Driven Content Management

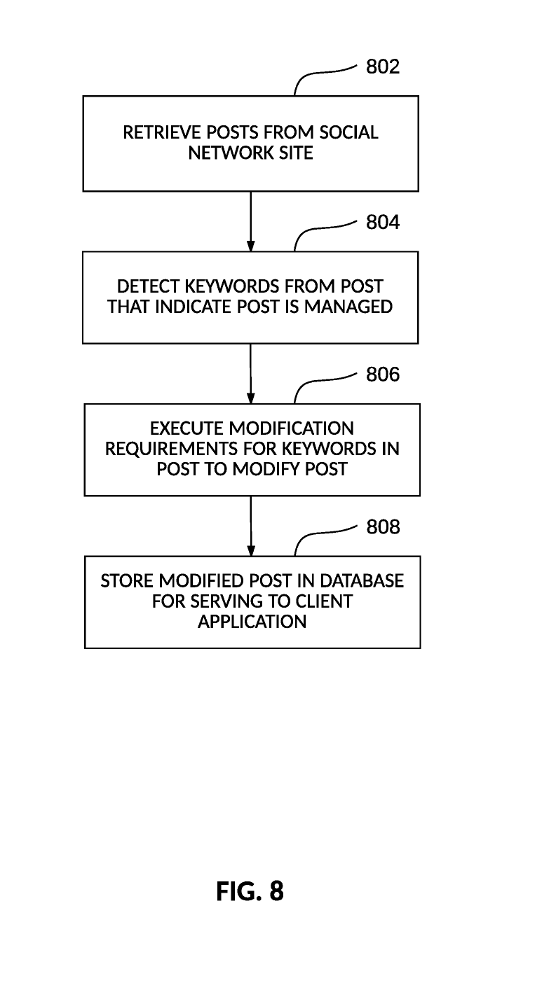

FIG. 8 illustrates an example of a flow diagram for a process employed by posts enrichment module 110 to manage the sponsored posts handled by the enhanced social media system 100. At step 802, system 100 retrieves a post from a social network site. At step 804, the system detects if any keywords are present in the metadata to indicate that this is a managed post. If there are keywords present, then at step 806, the modification requirements for the keywords are executed. At step 808, the modified post is stored in the database. In some embodiments, the keywords are in the text of the post or within a hyperlink in the post. The keywords themselves can comprise instructions to indicate to the enhanced social media system 100 to modify the post in a particular way, for example, changing its appearance to match a mood or feeling associated with a keyword.

Other features, aspects and objects of the invention can be obtained from a review of the figures and the claims. It is to be understood that other embodiments of the invention can be developed and fall within the spirit and scope of the invention and claims.

The foregoing description of embodiments of the present invention has been provided for the purposes of illustration and description. It is not intended to be exhaustive or to limit the invention to the precise forms disclosed. Various additions, deletions and modifications are contemplated as being within its scope. The scope of the invention is, therefore, indicated by the appended claims rather than the foregoing description. Further, all changes which may fall within the meaning and range of equivalency of the claims and elements and features thereof are to be embraced within their scope.

1. A system for aggregating, classifying, and enriching social media posts made by monitored author sources, the system comprising:
processing circuitry configured to:
identify a set of authors from a plurality of databases storing ranking data, wherein the set of authors comprises one or more of public figures, brands, or business entities;
identify a plurality of social media accounts authored by each author of the set of authors, the identifying further comprising, for each author of the set of authors, submitting a query to a web search engine comprising at least the author and a social media platform name, performing Bayesian probability evaluation on a set of ranked search results returned from the web search engine to evaluate a probability of authorship, wherein a top search result of the set of ranked search results is assigned the highest probability of authorship and is utilized as a prior probability in the Bayesian probability evaluation and wherein the probability is assigned to each of the remaining results of the set of ranked search results based on the prior, and based on said probability of authorship, identifying the plurality of social media accounts authored by each author of the set of authors;
after identifying the author of the social media accounts, interact with APIs provided by a plurality of social media platforms to retrieve a set of posts from said plurality of social media accounts authored by each author of the set of authors;
after identifying the author of the social media accounts, perform at least two levels of semantic analysis on the set of posts to assign at least two categories of a plurality of system categories to a post of the set of posts, the first level of semantic analysis for assigning an identity-type category based on the author of the post, and the second level of semantic analysis for assigning a content-type category; and
after identifying the author of the social media accounts and performing the at least two levels of semantic analysis, analyze the content of posts for one or more keywords, and for modifying posts by adding a hyperlink to the post relevant to said one or more keywords.

2.-4. (canceled)

5. The system of claim 1, wherein identity-type categories include musician, actor, athlete, miscellaneous celebrity, news and lifestyle, brand, or business entity, and the semantic analysis module employs machine learning processes, including K-Nearest Neighbors, Random Forrest or Support Vector Machine algorithms to classify posts of the set of posts into one of said identity-type categories.

6. The system of claim 1, wherein content-type categories include music, videos, photos, upcoming events, location-specific posts, concerts, news and lifestyle, and community interaction, and the processing circuitry employs supervised and unsupervised machine learning processes on text content of posts of the set of posts to classify the posts into one of said content-type categories.

7. The system of claim 1, wherein the analyzing the content of posts includes parsing text content of posts to identify one or more sponsored keywords, and said hyperlink added to a post is a hyperlink to a retail source for purchasing the product identified by the keyword.

8. The system of claim 1, wherein the one or more keywords includes URLs to a retail product information page for one or more products relating to the one or more keywords, the processing circuitry further configured to determine an alternative retail source for the product of the retail product information page by analyze text content obtained from said retail product information page, and said hyperlink added to a post is the alternative retail source for purchasing the product.

9. The system of claim 1, wherein the processing circuitry analyzes text content from posts to identify date markers, converting date markers within text content of posts into an event date attribute, and utilizing the event date attribute to arrange a plurality of event-category posts by order of the event date attribute.

10. The system of claim 9, wherein the analyzing text content from posts to identify date markers includes performing supervised machine learning processes to determine date markers from posts once a set of date markers for a set of training posts are determined.

11. (canceled)

12. A computer-implemented method for aggregating, classifying, and enriching social media posts made by monitored author sources, the method comprising:
identifying a set of authors from querying a plurality of databases storing ranking data wherein the set of authors comprises one or more of public figures, brands, or business entities;
identifying a plurality of social media accounts authored by each author of the set of authors, the identifying further comprising, for each author of the set of authors, submitting a query to a web search engine comprising at least the author and a social media platform name, performing Bayesian probability evaluation on a set of ranked search results returned from the web search engine to evaluate a probability of authorship, wherein a top search result of the set of ranked search results is assigned the highest probability of authorship and is utilized as a prior probability in the Bayesian probability evaluation and wherein the probability is assigned to each of the remaining results of the set of ranked search search results based on the prior, and based on said probability of authorship, identifying the plurality of social media accounts authored by each author of the set of authors;
after identifying the author of the social media accounts, interacting with APIs provided by the plurality of social media platforms to retrieve a set of posts from said plurality of social media accounts authored by each author of the set of authors;
after identifying the author of the social media accounts, performing at least two levels of semantic analysis on the set of posts to assign at least two categories of a plurality of system categories to a post of the set of posts, the first level of semantic analysis for assigning an identity-type category based on the author of the post, and the second level of semantic analysis for assigning a content-type category; and
after identifying the author of the social media accounts and performing the at least two levels of semantic analysis, analyzing the content of posts for one or more hyperlinks, and modifying posts by adding, or substituting the one or more hyperlinks with, an alternative hyperlink.

13.-15. (canceled)

16. The method of claim 12, wherein identity-type categories include musician, actor, athlete, miscellaneous celebrity, news and lifestyle, brand, or business entity, and further comprising employing machine learning processes, including K-Nearest Neighbors, Random Forrest or Support Vector Machine algorithms to classify posts of the set of posts into one of said identity-type categories.

17. The method of claim 12, wherein content-type categories include music, videos, photos, upcoming events, location-specific posts, concerts, news and lifestyle, and community interaction, further comprising employing supervised and unsupervised machine learning processes on text content of posts of the set of posts to classify the posts into one of said content-type categories.

18. The method of claim 12, wherein the analyzing the content of posts includes parsing text content of posts to identify one or more sponsored keywords, and said hyperlink added to a post is a hyperlink to a retail source for purchasing the product identified by the keyword.

19. The method of claim 12, wherein the one or more keywords includes URLs to a retail product information page for one or more products relating to the one or more keywords, and further comprising determining an alternative retail source for the product of the retail product information page by analyze text content obtained from said retail product information page, and said hyperlink added to a post is the alternative retail source for purchasing the product.

20. The method of claim 12, further comprising analyzing text content from posts to identify date markers, converting date markers within text content of posts into an event date attribute, and utilizing the event date attribute to arrange a plurality of event-category posts by order of the event date attribute.

21. The method of claim 20, wherein the analyzing text content from posts to identify date markers includes performing supervised machine learning processes to determine date markers from posts once a set of date markers for a set of training posts are determined.

22. (canceled)
